(19) United States
(12) Patent Application Publication
(10) Pub. No.: US 2019/0393966 A1
(43) Pub. Date: Dec. 26, 2019

(54) PARAMETRIC ARRAY SYSTEM

(71) Applicant: Mitsubishi Electric Engineering Company, Limited, Chiyoda-ku (JP)

(72) Inventor: Shunji YOSHIDA, Chiyoda-ku (JP)

(73) Assignee: Mitsubishi Electric Engineering Company, Limited, Chiyoda-ku (JP)

(21) Appl. No.: 16/469,500

(22) PCT Filed: Feb. 1, 2017
(86) PCT No.: PCT/JP2017/003595

§ 371 Date: Jun. 13, 2019

(51) Int. Cl. H04B 11/00

(52) U.S. Cl. CPC H04B 11/00

(57) ABSTRACT

There are included a carrier wave generating unit (4) that generates a carrier wave signal; a modulating unit (6) that generates a modulated wave signal obtained by amplitude-modulating the carrier wave signal generated by the carrier wave generating unit (4) using an audio signal; an absolute value converting unit (7) that converts the audio signal into an absolute value; an exponentially weighted moving average unit (8) that performs an exponentially weighted moving average process on the audio signal converted by the absolute value converting unit (7), using an audio signal obtained one sampling period ago, to estimate a sound pressure level of the audio signal; and a multiplying unit (10) that multiplies the carrier wave signal generated by the carrier wave generating unit (4) by the sound pressure level estimated by the exponentially weighted moving average unit (8).

### TECHNICAL FIELD

The invention relates to a parametric array system that emits audible sound into a narrow area using a carrier wave signal in an ultrasonic band.

### BACKGROUND ART

A parametric array system adds a modulated wave signal obtained by amplitude-modulating a carrier wave signal in an ultrasonic band using an audio signal which is audible sound, to the carrier wave signal and emits the added signal from an ultrasonic emitter. By this, in air, due to nonlinear interaction between the carrier wave signal and the modulated wave signal, a difference tone between the carrier wave signal and the modulated wave signal occurs, and thus the audible sound is self-demodulated.

This parametric array system reduces power consumption by changing the sound pressure level of a carrier wave signal to be emitted, depending on fluctuations in the sound pressure level of an audio signal (see, for example, Patent Literature 1). In a method disclosed in Patent Literature 1, out of outputs of a Hilbert filter, some signals are delayed by delay lines and an instantaneous envelope is detected from the other signals, to monitor the sound pressure level of an audio signal, and the sound pressure level of a carrier wave signal is changed on the basis of a result of the detection.

### CITATION LIST

### Patent Literatures

Patent Literature 1: JP 2005-527992 A

### SUMMARY OF INVENTION

### Technical Problem

However, in the method disclosed in Patent Literature 1, since the sound pressure level of an audio signal is monitored, out of outputs of the Hilbert filter, some signals need to be delayed. In addition, the Hilbert filter has, for example, as shown in FIG. 9, multiple delaying units. As such, the method disclosed in Patent Literature 1 has a problem that a practically influential delay occurs.

In addition, since the Hilbert filter has, as shown in FIG. 9, multiple delaying units and multiple adding units, there is a problem of an increase in circuit size and an increase in cost.

The invention is made to solve problems such as those described above, and an object of the invention is to provide a parametric array system with no practical delay.

### Solution to Problem

A parametric array system according to the invention includes: a carrier wave generating unit for generating a carrier wave signal; a modulating unit for generating a modulated wave signal obtained by amplitude-modulating the carrier wave signal using an audio signal, the carrier wave signal being generated by the carrier wave generating unit; an absolute value converting unit for converting the audio signal into an absolute value; at least one exponentially weighted moving average unit for performing an exponentially weighted moving average process on the audio signal converted by the absolute value converting unit, using an audio signal obtained one sampling period ago, to estimate a sound pressure level of the audio signal; and a multiplying unit for multiplying the carrier wave signal by the sound pressure level estimated by the exponentially weighted moving average unit, the carrier wave signal being generated by the carrier wave generating unit.

### Advantageous Effects of Invention

According to the invention, since a configuration is formed in the above-described manner, there is no practical delay.

### BRIEF DESCRIPTION OF DRAWINGS

FIG. 1 is a block diagram showing an exemplary schematic configuration of a parametric array system according to a first embodiment of the invention.

FIG. 2 is a block diagram showing an exemplary schematic configuration of an SSB-modulating unit in the first embodiment of the invention.

FIG. 3 is a block diagram showing an exemplary schematic configuration of an exponentially weighted moving average unit in the first embodiment of the invention.

FIG. 4 is a flowchart showing exemplary operation of the parametric array system according to the first embodiment of the invention.

FIGS. 5A to 5D are diagrams showing an example of advantageous effects of the parametric array system according to the first embodiment of the invention.

FIG. 6 is a diagram showing an exemplary schematic configuration of an exponentially weighted moving average unit of a second embodiment of the invention.

FIGS. 7A to 7C are diagrams showing an example of advantageous effects of a parametric array system according to the second embodiment of the invention.

FIGS. 8A to 8C are diagrams showing another example of advantageous effects of the parametric array system according to the second embodiment of the invention.

FIG. 9 is a block diagram showing an exemplary schematic configuration of a Hilbert filter used in a conventional parametric array system.

### DESCRIPTION OF EMBODIMENTS

Embodiments of the invention will be described in detail below with reference to the drawings.

### First Embodiment

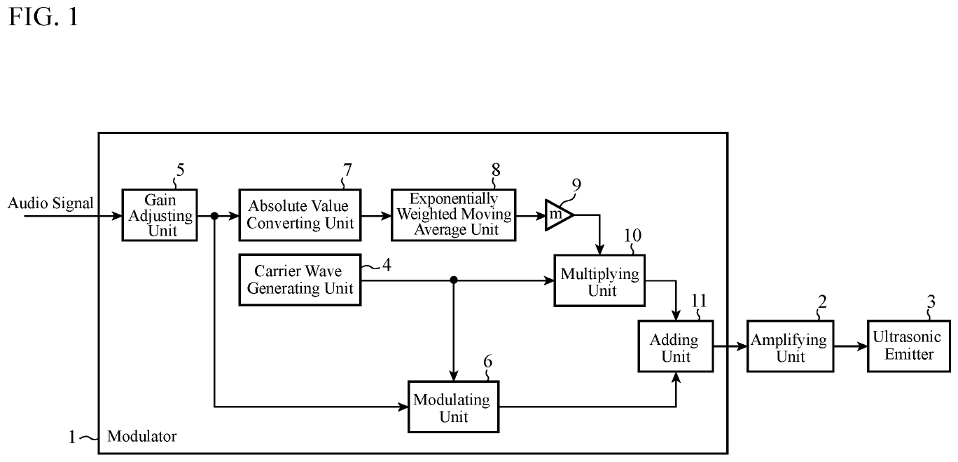

FIG. 1 is a block diagram showing an exemplary configuration of a parametric array system according to a first embodiment of the invention.

The parametric array system includes, as shown in FIG. 1, a modulator 1, an amplifying unit 2, and an ultrasonic emitter 3. In addition, the modulator 1 includes a carrier wave generating unit 4, a gain adjusting unit 5, a modulating unit 6, an absolute value converting unit 7, an exponentially weighted moving average unit 8, an amplifying unit 9, a multiplying unit 10, and an adding unit 11.

The carrier wave generating unit 4 generates a carrier wave signal in an ultrasonic band. The carrier wave signal generated by the carrier wave generating unit 4 is outputted to the modulating unit 6 and the multiplying unit 10.

The gain adjusting unit 5 adjusts the gain (amplitude) of an audio signal which is audible sound inputted. At this time, the gain adjusting unit 5 adjusts the gain of the above-described audio signal to a value with which processes at subsequent stages can be performed. The audio signal whose gain has been adjusted by the gain adjusting unit 5 is outputted to the modulating unit 6 and the absolute value converting unit 7.

The modulating unit 6 generates a modulated wave signal obtained by amplitude-modulating the carrier wave signal generated by the carrier wave generating unit 4 using the audio signal whose gain has been adjusted by the gain adjusting unit 5. As the modulating unit 6, a single-sideband (SSB)-modulating unit that performs SSB modulation or a double-sideband (DSB)-modulating unit that performs DSB modulation is used. The modulated wave signal generated by the modulating unit 6 is outputted to the adding unit 11.

The absolute value converting unit 7 converts the audio signal whose gain has been adjusted by the gain adjusting unit 5 into an absolute value. The audio signal having been converted into an absolute value by the absolute value converting unit 7 is outputted to the exponentially weighted moving average unit 8.

The exponentially weighted moving average unit 8 performs an exponentially weighted moving average process on the audio signal having been converted into an absolute value by the absolute value converting unit 7, using an audio signal obtained one sampling period ago, to estimate a sound pressure level of the audio signal. A signal indicating the sound pressure level estimated by the exponentially weighted moving average unit 8 is outputted to the amplifying unit 9.

The amplifying unit 9 amplifies the signal indicating the sound pressure level estimated by the exponentially weighted moving average unit 8. The signal amplified by the amplifying unit 9 is outputted to the multiplying unit 10.

The multiplying unit 10 multiplies the carrier wave signal generated by the carrier wave generating unit 4 by the signal amplified by the amplifying unit 9. By the multiplying unit 10, the carrier wave signal is converted into a sound pressure level required and sufficient for self-demodulation of the audible sound.

The adding unit 11 adds the carrier wave signal whose sound pressure level has been converted by the multiplying unit 10 to the modulated wave signal generated by the modulating unit 6. A signal obtained by adding the carrier wave signal to the modulated wave signal by the adding unit 11 is outputted to the amplifying unit 2.

The amplifying unit 2 amplifies the signal obtained by adding the carrier wave signal to the modulated wave signal by the adding unit 11. At this time, the amplifying unit 2 amplifies the above-described signal to a level at which the ultrasonic emitter 3 can be driven. The signal amplified by the amplifying unit 2 is outputted to the ultrasonic emitter 3.

The ultrasonic emitter 3 emits the signal amplified by the amplifying unit 2 into air. The ultrasonic emitter 3 includes a plurality of ultrasonic emitter elements (not shown).

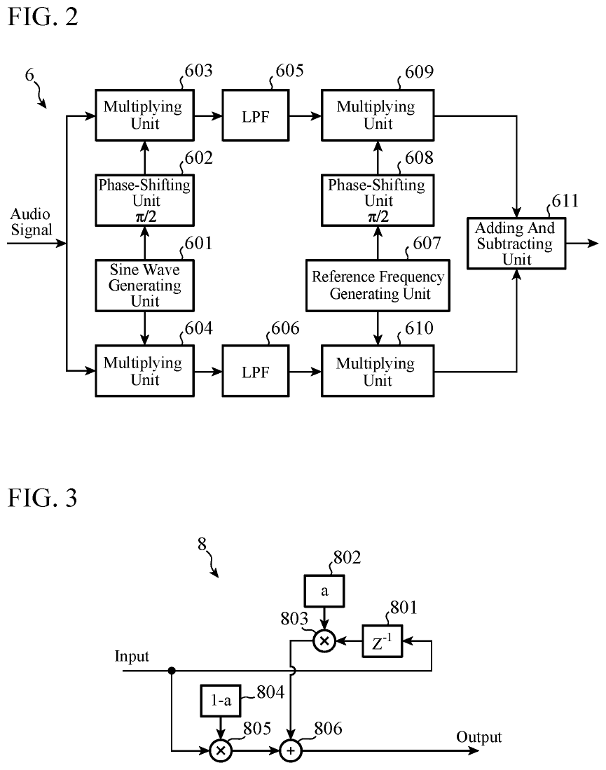

Next, an exemplary configuration of the modulating unit 6 will be described with reference to FIG. 2. FIG. 2 shows a case of using, as the modulating unit 6, an SSB-modulating unit that performs SSB modulation using the Weaver's method with little delay.

The modulating unit 6 includes, as shown in FIG. 2, a sine wave generating unit 601, a phase-shifting unit 602, a multiplying unit 603, a multiplying unit 604, a low-pass filter (LPF) 605, a low-pass filter (LPF) 606, a reference frequency generating unit 607, a phase-shifting unit 608, a multiplying unit 609, a multiplying unit 610, and an adding and subtracting unit 611.

The sine wave generating unit 601 generates a sine wave signal having the center frequency of the band of an audio signal. The sine wave signal generated by the sine wave generating unit 601 is outputted to the phase-shifting unit 602 and the multiplying unit 604.

Here, when the frequency band of an audio signal handled by the parametric array system is, for example, 0.5 [kHz] to 8.0 [kHz], the center frequency of the band is 4.25 [kHz]. Note that in general a frequency band of the order of 0.3 [kHz] to 10.0 [kHz] is often handled as an audio signal.

The phase-shifting unit 602 advances the phase of the sine wave signal generated by the sine wave generating unit 601 by π/2 [rad.]. The sine wave signal whose phase has been advanced by π/2 [rad.] by the phase-shifting unit 602 is outputted to the multiplying unit 603.

The multiplying unit 603 multiplies an audio signal whose gain has been adjusted by the gain adjusting unit 5, by the sine wave signal whose phase has been advanced by π/2 [rad.] by the phase-shifting unit 602. Namely, the multiplying unit 603 generates a modulated wave signal obtained by amplitude-modulating (DSB-modulating) the audio signal using, as a subcarrier wave signal, the sine wave signal whose phase has been advanced by π/2 [rad.]. The modulated wave signal generated by the multiplying unit 603 is outputted to the low-pass filter 605.

The multiplying unit 604 multiplies the audio signal whose gain has been adjusted by the gain adjusting unit 5, by the sine wave signal generated by the sine wave generating unit 601. Namely, the multiplying unit 604 generates a modulated wave signal obtained by amplitude-modulating (DSB-modulating) the audio signal using, as a subcarrier wave signal, the sine wave signal whose phase has not been shifted. The modulated wave signal generated by the multiplying unit 604 is outputted to the low-pass filter 606.

The low-pass filter 605 extracts only a low-frequency signal which is lower than or equal to the center of the band of the audio signal, from the modulated wave signal generated by the multiplying unit 603. Namely, the low-pass filter 605 is a low-pass filter whose cut-off frequency is the center frequency of the band of the audio signal, and cuts sideband components of an upper-side band of the above-described modulated wave signal, and extracts only sideband components of a lower-side band. The signal extracted by the low-pass filter 605 is outputted to the multiplying unit 609.

The low-pass filter 606 extracts only a low-frequency signal which is lower than or equal to the center of the band of the audio signal, from the modulated wave signal generated by the multiplying unit 604. Namely, the low-pass filter 606 is a low-pass filter whose cut-off frequency is the center frequency of the band of the audio signal, and cuts sideband components of an upper-side band of the above-described modulated wave signal, and extracts only sideband components of a lower-side band. The signal extracted by the low-pass filter 606 is outputted to the multiplying unit 610.

The reference frequency generating unit 607 generates, on the basis of a carrier wave signal generated by the carrier wave generating unit 4, a sine wave signal (reference frequency signal) with a frequency shifted by the center frequency of the band of the audio signal relative to the frequency of the carrier wave signal. The sine wave signal generated by the reference frequency generating unit 607 is outputted to the phase-shifting unit 608 and the multiplying unit 610.

For example, when the center frequency of the band of the audio signal is 4.25 [kHz] and the frequency of the carrier wave signal is fc, the reference frequency generating unit 607 generates a sine wave signal with a frequency of fc+4.25 [kHz] or fc−4.25 [kHz]. Note that which one of fc+4.25 [kHz] and fc−4.25 [kHz] to be used as the frequency of a sine wave signal to be generated by the reference frequency generating unit 607 depends on modulation operation performed by the modulator 1.

Note that the above description shows a case in which the reference frequency generating unit 607 generates a sine wave signal on the basis of a carrier wave signal generated by the carrier wave generating unit 4. However, the configuration is not limited thereto, and the frequency of a sine wave signal to be generated by the reference frequency generating unit 607 may be set by the reference frequency generating unit 607 itself

The phase-shifting unit 608 advances the phase of the sine wave signal generated by the reference frequency generating unit 607 by π/2 [rad.]. The sine wave signal whose phase has been advanced by π/2 [rad.] by the phase-shifting unit 608 is outputted to the multiplying unit 609.

The multiplying unit 609 multiples the signal extracted by the low-pass filter 605, by the sine wave signal whose phase has been advanced by π/2 [rad.] by the phase-shifting unit 608. Namely, the multiplying unit 609 generates a signal whose upper sideband and lower sideband have opposite phases. The signal generated by the multiplying unit 609 is outputted to the adding and subtracting unit 611.

The multiplying unit 610 multiples the signal extracted by the low-pass filter 606, by the sine wave signal generated by the reference frequency generating unit 607. Namely, the multiplying unit 610 generates a signal whose upper and lower sidebands are in phase. The signal generated by the multiplying unit 610 is outputted to the adding and subtracting unit 611.

The adding and subtracting unit 611 adds the signal generated by the multiplying unit 609 to the signal generated by the multiplying unit 610, or subtracts the signal generated by the multiplying unit 609 from the signal generated by the multiplying unit 610. Note that which process of addition and subtraction to be performed by the adding and subtracting unit 611 depends on fluctuation operation performed by the modulator 1.

For example, when the modulator 1 generates a modulated wave signal using the sideband components of the upper-side band, the reference frequency generating unit 607 generates a sine wave signal with a frequency of fc+4.25 [kHz], and the adding and subtracting unit 611 adds the signal generated by the multiplying unit 609 to the signal generated by the multiplying unit 610. By this addition process, opposite-phase components cancel each other out, and a modulated wave signal having in-phase sideband components of the upper-side band is generated.

In addition, when the modulator 1 generates a modulated wave signal using the sideband components of the lower-side band, the reference frequency generating unit 607 generates a sine wave signal with a frequency of fc−4.25 [kHz], and the adding and subtracting unit 611 subtracts the signal generated by the multiplying unit 609 from the signal generated by the multiplying unit 610. By this subtraction process, in-phase components cancel each other out, and a modulated wave signal having opposite-phase sideband components of the lower-side band is generated.

Note that out of the sideband components of the upper-side band and the sideband components of the lower-side band, the modulating unit 6 uses sideband components of the band with which a signal can be efficiently emitted, depending on the sound pressure frequency characteristics of a signal emitted from the ultrasonic emitter 3.

In addition, the above description shows a case of using, as the modulating unit 6, an SSB-modulating unit that performs SSB modulation using the Weaver's method. However, the configuration is not limited thereto, and for example, an SSB-modulating unit that performs SSB modulation using the Merigo method disclosed in Non-Patent Literature 1 may be used as the modulating unit 6. Non-Patent Literature 1: CQ Publishing, Co., Ltd., Ham Journal No. 86, August 1993, “SSB Generator and SSB Demodulator Using the Merigo Method”

Next, an exemplary configuration of the exponentially weighted moving average unit 8 will be described with reference to FIG. 3.

The exponentially weighted moving average unit 8 includes, as shown in FIG. 3, a delaying unit 801, a constant setting unit 802, a multiplying unit 803, a constant setting unit 804, a multiplying unit 805, and an adding unit 806.

The delaying unit 801 delays an audio signal having been converted by the absolute value converting unit 7 by one sampling period. The audio signal having been delayed by the delaying unit 801 is outputted to the multiplying unit 803.

The constant setting unit 802 sets a constant a. The constant a is set as appropriate in a range of greater than 0.5 and less than 1, depending on the number of samples (resolution) of the audio signal in the parametric array system. Namely, the exponentially weighted moving average unit 8 assigns a high weight to an audio signal obtained one sampling period ago. Note that the closer the value of the constant a is to 1, the smoother the estimated value curve of the sound pressure level of the audio signal can be made. A signal indicating the constant a set by the constant setting unit 802 is outputted to the multiplying unit 803.

The multiplying unit 803 multiplies the audio signal having been delayed by the delaying unit 801 by the constant a set by the constant setting unit 802. The audio signal obtained one sampling period ago, which has been multiplied by the constant a by the multiplying unit 803, is outputted to the adding unit 806.

The constant setting unit 804 sets a constant (1-a). A signal indicating the constant (1-a) set by the constant setting unit 804 is outputted to the multiplying unit 805.

The multiplying unit 805 multiplies the audio signal having been converted by the absolute value converting unit 7 by the constant (1-a) set by the constant setting unit 804. The audio signal having been multiplied by the constant (1-a) by the multiplying unit 805 is outputted to the adding unit 806.

The adding unit 806 adds the audio signal obtained one sampling period ago, which has been multiplied by the constant a by the multiplying unit 803, to the audio signal having been multiplied by the constant (1-a) by the multiplying unit 805.

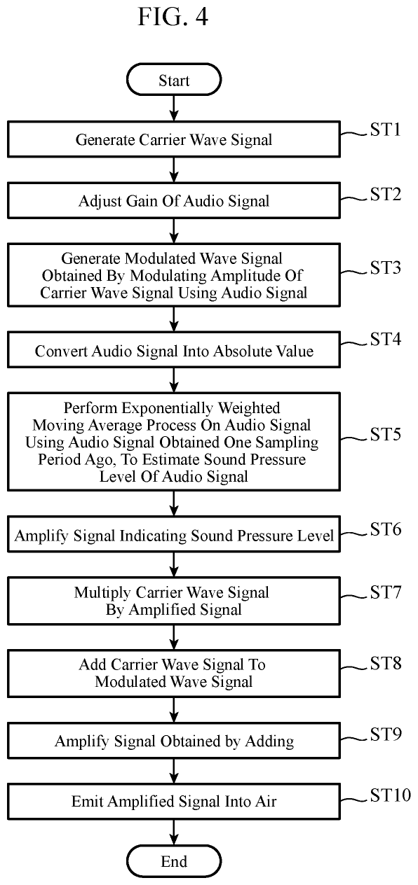

Next, exemplary operation of the parametric array system according to the first embodiment will be described with reference to FIG. 4.

In the parametric array system according to the first embodiment, as shown in FIG. 4, first, the carrier wave generating unit 4 generates a carrier wave signal in an ultrasonic band (step ST1).

In addition, the gain adjusting unit 5 adjusts the gain of an audio signal which is audible sound inputted (step ST2).

Then, the modulating unit 6 generates a modulated wave signal obtained by amplitude-modulating the carrier wave signal generated by the carrier wave generating unit 4 using the audio signal whose gain has been adjusted by the gain adjusting unit 5 (step ST3).

In addition, the absolute value converting unit 7 converts the audio signal whose gain has been adjusted by the gain adjusting unit 5 into an absolute value (step ST4).

Then, the exponentially weighted moving average unit 8 performs an exponentially weighted moving average process on the audio signal having been converted into an absolute value by the absolute value converting unit 7, using an audio signal obtained one sampling period ago, to estimate a sound pressure level of the audio signal (step ST5).

Then, the amplifying unit 9 amplifies a signal indicating the sound pressure level estimated by the exponentially weighted moving average unit 8 (step ST6).

Then, the multiplying unit 10 multiplies the carrier wave signal generated by the carrier wave generating unit 4 by the signal amplified by the amplifying unit 9 (step ST7). By this, the sound pressure level of the carrier wave signal is changed depending on fluctuations in the sound pressure level of the audio signal.

Then, the adding unit 11 adds the carrier wave signal whose sound pressure level has been converted by the multiplying unit 10 to the modulated wave signal generated by the modulating unit 6 (step ST8).

Then, the amplifying unit 2 amplifies a signal obtained by adding the carrier wave signal to the modulated wave signal by the adding unit 11 (step ST9).

Then, the ultrasonic emitter 3 emits the signal amplified by the amplifying unit 2 into air (step ST10). Thereafter, the signal (the carrier wave signal and the modulated wave signal) emitted by the ultrasonic emitter 3 is self-demodulated into audible sound in air, forming a beam-like sound field.

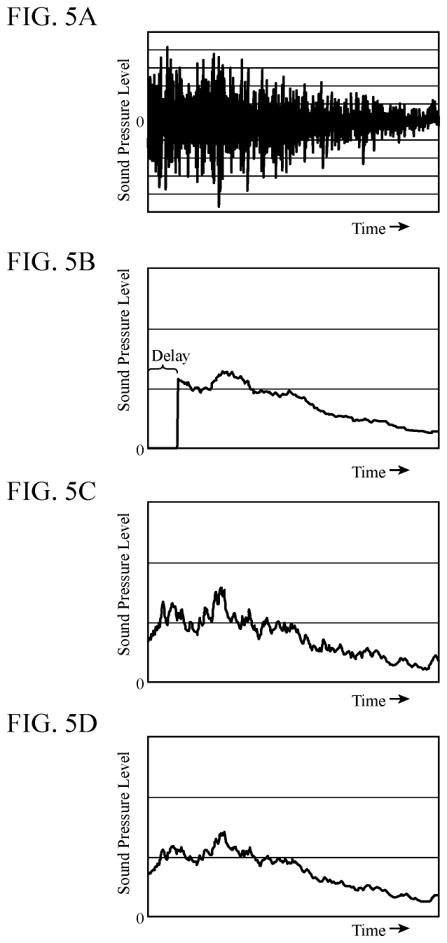

Next, the advantageous effects of the parametric array system according to the first embodiment will be described with reference to FIG. 5. FIG. 5A shows an audio signal inputted to a parametric array system. In addition, FIG. 5B shows the results of monitoring the sound pressure level of the audio signal by a conventional parametric array system. In addition, FIGS. 5C and 5D show the results of estimating the sound pressure level of the audio signal by the parametric array system according to the first embodiment.

In the conventional parametric array system, as shown in FIG. 5B, a delay has occurred in the results of monitoring the sound pressure level of the audio signal.

On the other hand, in the parametric array system according to the first embodiment, as shown in FIGS. 5C and 5D, a delay has not occurred in the results of estimating the sound pressure level of the audio signal. Note that FIG. 5C shows the results of estimation for a case in which the constant a is 0.98 and the initial value of an audio signal obtained one sampling period ago is 0.15, and FIG. 5D shows the results of estimation for a case in which the constant a is 0.99 and the initial value of an audio signal obtained one sampling period ago is 0.15.

Here, in the parametric array system according to the first embodiment, the exponentially weighted moving average unit 8 performs an exponentially weighted moving average process in which a high weight is assigned to an audio signal obtained one sampling period ago, on an audio signal to estimate a sound pressure level of the audio signal. As such, since a process performed by the exponentially weighted moving average unit 8 is simple computation using only data obtained one sampling period ago, there is no practical delay and a small-sized circuit configuration can be implemented. In addition, since the exponentially weighted moving average unit 8 can be implemented by a small-sized circuit configuration, cost can be reduced.

In addition, the above description shows a case in which the adding unit 11 is provided in the modulator 1 and the ultrasonic emitter 3 emits a signal obtained by adding a carrier wave signal to a modulated wave signal. However, the configuration is not limited thereto, and the configuration may be in such a way that the adding unit 11 is not provided in the modulator 1 and the ultrasonic emitter 3 emits a carrier wave signal and a modulated wave signal in such a way that they are separated from each other.

As described above, according to the first embodiment, there are included the carrier wave generating unit 4 that generates a carrier wave signal; a modulating unit 6 that generates a modulated wave signal obtained by amplitude-modulating the carrier wave signal generated by the carrier wave generating unit 4 using an audio signal; the absolute value converting unit 7 that converts the audio signal into an absolute value; an exponentially weighted moving average unit 8 that performs an exponentially weighted moving average process on the audio signal converted by the absolute value converting unit 7, using an audio signal obtained one sampling period ago, to estimate a sound pressure level of the audio signal; and a multiplying unit 10 that multiplies the carrier wave signal generated by the carrier wave generating unit 4 by the sound pressure level estimated by the exponentially weighted moving average unit 8, and thus, there is no practical delay.

### Second Embodiment

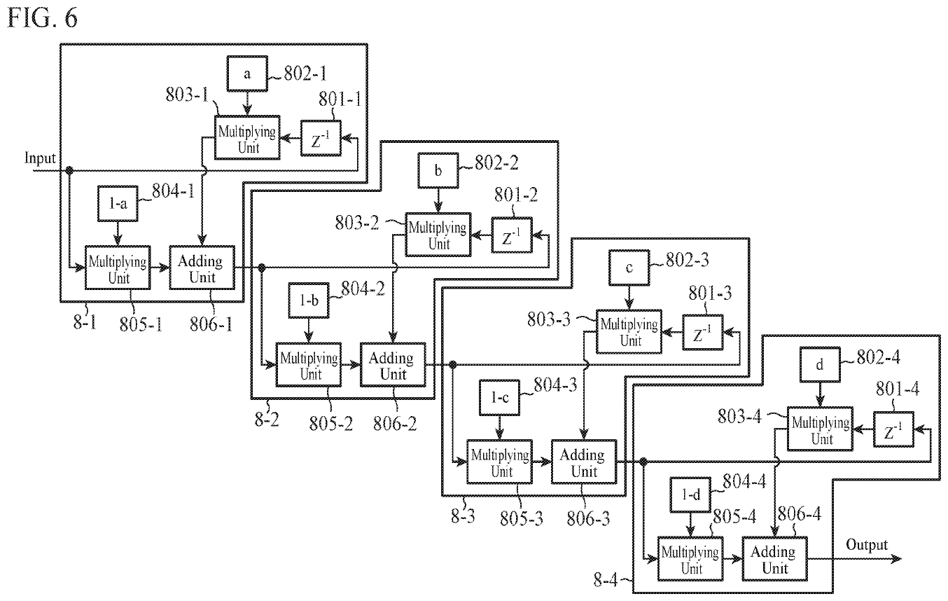

The first embodiment shows, as shown in FIG. 1, a case of using a single exponentially weighted moving average unit 8. However, the configuration is not limited thereto, and as shown in FIG. 6, a plurality of exponentially weighted moving average units 8 may be connected in series. FIG. 6 shows a case in which four exponentially weighted moving average units 8 (8-1 to 8-4) are connected in series.

Note that constants a to d used by the respective exponentially weighted moving average units 8 are in a range of greater than 0.5 and less than 1, and are set as appropriate depending on the number of samples of an audio signal in the parametric array system. Note that the constants a to d do not need to be identical and may have different values.

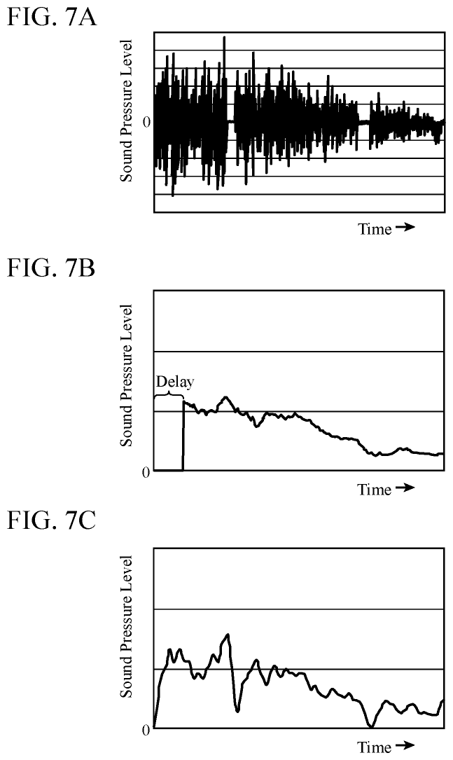

Next, the advantageous effects of the parametric array system according to the second embodiment will be described with reference to FIG. 7. FIG. 7A shows an audio signal inputted to a parametric array system. Note that the audio signal shown in FIG. 7A includes silent sections. In addition, FIG. 7B shows the results of monitoring the sound pressure level of the audio signal by a conventional parametric array system. In addition, FIG. 7C shows the results of estimating the sound pressure level of the audio signal by the parametric array system according to the second embodiment.

In the conventional parametric array system, as shown in FIG. 7B, a delay has occurred in the results of monitoring the sound pressure level of the audio signal. In addition, the results of monitoring shown in FIG. 7B have poor responsiveness to the silent sections.

On the other hand, in the parametric array system according to the second embodiment, as shown in FIG. 7C, a delay has not occurred in the results of estimating the sound pressure level of the audio signal. In addition, the results of estimation shown in FIG. 7C have excellent responsiveness to the silent sections. Note that FIG. 7C shows the results of estimation for a case in which the constant a is 0.9 and the constants b to d are 0.88, and the initial value of an audio signal obtained one sampling period ago is 0.15.

Here, in the parametric array system according to the second embodiment, the exponentially weighted moving average units 8 each perform an exponentially weighted moving average process in which a high weight is assigned to an audio signal obtained one sampling period ago, on an audio signal to estimate a sound pressure level of the audio signal. As such, since a process performed by each of the exponentially weighted moving average units 8 is simple computation using only data obtained one sampling period ago, there is no practical delay and a small-sized circuit configuration can be implemented. In addition, since each of the exponentially weighted moving average units 8 can be implemented by a small-sized circuit configuration, cost can be reduced.

In addition, by connecting the plurality of exponentially weighted moving average units 8 in series, an estimated value curve of the sound pressure level of the audio signal can be made smoother than that of the first embodiment.

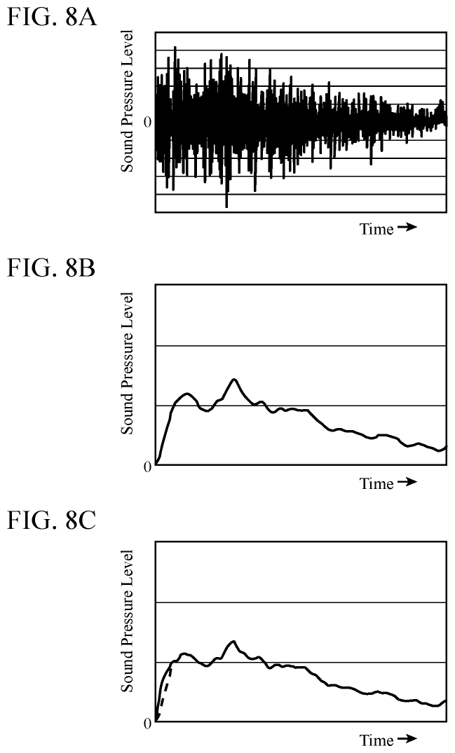

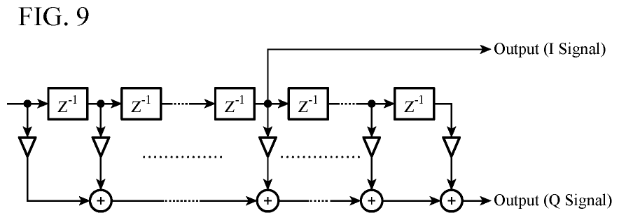

In addition, FIG. 8 shows differences in advantageous effect made by the setting of the constants a to d.

FIG. 8A shows an audio signal inputted to the parametric array system. In addition, FIG. 8B shows the results of estimating the sound pressure level of the audio signal by the parametric array system according to the second embodiment, for a case in which the constants a to d are 0.965 and the initial value of an audio signal obtained one sampling period ago is 0.15. In addition, FIG. 8C shows the results of estimating the sound pressure level of the audio signal by the parametric array system according to the second embodiment, for a case in which the constant a is 0.99 and the constants b to d are 0.95, and the initial value of an audio signal obtained one sampling period ago is 0.15. Note that a dashed line in FIG. 8C indicates a rise of the results of estimation shown in FIG. 8B.

As shown in FIGS. 8B and 8C, by appropriately setting the constants a to d, an estimated value curve with excellent responsiveness (a steep rise and fall of a waveform) can be obtained.

Note that in the invention of the present application, a free combination of the embodiments, modifications to any component of the embodiments, or omissions of any component in the embodiments are possible within the scope of the invention.

### INDUSTRIAL APPLICABILITY

Parametric array systems according to the invention have no practical delay, and thus are suitable for use as parametric array systems each of which emits audible sound into a narrow area using a carrier wave signal in an ultrasonic band, etc.

### REFERENCE SIGNS LIST

1: Modulator, 2: Amplifying unit, 3: Ultrasonic emitter, 4: Carrier wave generating unit, 5: Gain adjusting unit, 6: Modulating unit, 7: Absolute value converting unit, 8: Exponentially weighted moving average unit, 9: Amplifying unit, 10: Multiplying unit, 11: Adding unit, 601: Sine wave generating unit, 602: Phase-shifting unit, 603: Multiplying unit, 604: Multiplying unit, 605: Low-pass filter, 606: Low-pass filter, 607: Reference frequency generating unit, 608: Phase-shifting unit, 609: Multiplying unit, 610: Multiplying unit, 611: Adding and subtracting unit, 801: Delaying unit, 802: Constant setting unit, 803: Multiplying unit, 804: Constant setting unit, 805: Multiplying unit, and 806: Adding unit.

1. A parametric array system comprising:
a carrier wave generator to generate a carrier wave signal;
a modulator to generate a modulated wave signal obtained by amplitude-modulating the carrier wave signal using an audio signal, the carrier wave signal being generated by the carrier wave generator;
an absolute value converter to convert the audio signal into an absolute value;
at least one exponentially weighted moving average processor to perform an exponentially weighted moving average process on the audio signal converted by the absolute value converter, using an audio signal obtained one sampling period ago, to estimate a sound pressure level of the audio signal; and
a multiplier to multiply the carrier wave signal by the sound pressure level estimated by the exponentially weighted moving average processor, the carrier wave signal being generated by the carrier wave generator.

2. The parametric array system according to claim 1, wherein a plurality of the exponentially weighted moving average processors are connected in series.

3. The parametric array system according to claim 1, wherein the modulator is an SSB-modulator to perform SSB-modulation on the carrier wave signal using the audio signal, the carrier wave signal being generated by the carrier wave generator.

4. The parametric array system according to claim 3, wherein the SSB-modulator performs SSB modulation using Weaver's method.

5. The parametric array system according to claim 3, wherein the SSB-modulator performs SSB modulation using Merigo method.
